(19) United States
(12) Patent Application Publication
(10) Pub. No.: US 2015/0334775 A1
(43) Pub. Date: Nov. 19, 2015

(54) HIGH SPEED OVEN INCLUDING WIRE MESH HEATING ELEMENTS

(71) Applicant: DE LUCA OVEN TECHNOLOGIES, LLC, San Francisco, CA (US)

(72) Inventor: Nicholas P. De Luca, Carmel-by-the-Sea, CA (US)

(21) Appl. No.: 14/432,853

(22) PCT Filed: Sep. 30, 2013
(86) PCT No.: PCT/US13/62767

§ 371 Date: Jul. 15, 2015

Related U.S. Application Data
(60) Provisional application No. 61/708,599, filed on Oct. 1, 2012.
(60) Provisional application No. 61/708,602, filed on Oct. 1, 2012.

(51) Int. Cl. H05B 3/00; H05B 3/02; A21B 1/22; H05B 3/42

(52) U.S. Cl. CPC H05B 3/0014; H05B 3/42; H05B 3/026; A21B 1/22

(57) ABSTRACT

A radiant oven including multiple wire-mesh elements and a method of heating with the same is described. The radiant oven including: a cooking cavity configured to receive a cooking load; a circuit configured to current supplied by one or more stored energy devices; and a main heater comprising a multiple of wire mesh heating elements to be driven by the current, the multiple wire mesh heating elements being sized and positioned to heat the cooking load, and a gap between each of the multiple wire mesh heating elements.

### BACKGROUND

A method for heating involves the use of Nichrome wire. Nichrome wire is commonly used in appliances such as hair dryers and toasters as well as used in embedded ceramic heaters. The wire has a high tensile strength and can easily operate at temperatures as high as 1250 degrees Celsius. Nichrome has the following physical properties (Standard ambient temperature and pressure used unless otherwise noted):

| Material property | Value | Units |
|---|---|---|
| Tensile Strength | 2.8 × 10⁸ | Pa |
| Modulus of elasticity | 2.2 × 10¹¹ | Pa |
| Specific gravity | 8.4 | None |
| Density | 8400 | kg/m³ |
| Melting point | 1400 | ° C. |
| Electrical resistivity at room | 1.08 × 10^{-6[1]} | Ω · m |
| temperature | | |
| Specific heat | 450 | J/kg° C. |
| Thermal conductivity | 11.3 | W/m/° C. |
| Thermal expansion | 14 × 10⁻⁶ | m/m/° C. |

### SUMMARY OF THE INVENTION

Exemplary embodiments of the present invention disclose a radiant oven including: a cooking cavity configured to receive a cooking load; a circuit configured to current supplied by one or more stored energy devices; and a main heater comprising a multiple of wire mesh heating elements to be driven by the current, the multiple wire mesh heating elements being sized and positioned to heat the cooking load, and a gap between each of the multiple wire mesh heating elements.

Exemplary embodiments of the present invention disclose a heating method including: locating a cooking load into a heating cavity including multiple wire mesh heaters; and discharging current from a stored energy source through the one or more wire mesh heaters.

It is to be understood that both the foregoing general description and the following detailed description are exemplary and explanatory and are intended to provide further explanation of the invention as claimed.

### BRIEF DESCRIPTION OF THE FIGURES

The accompanying drawings, which are included to provide a further understanding of the invention and are incorporated in and constitute a part of this specification, illustrate embodiments of the invention, and together with the description serve to explain the principles of the invention.

FIG. 1 is a graph illustrating the radiative area of a mesh element as a function of the center to center spacing of the mesh strands.

FIG. 2 is a graph illustrating the electrical resistance of a mesh element as a function of the radius of the strand and the mesh spacing.

FIG. 3 is a graph illustrating the ramp up time of a two sided 125 mm×250 mm mesh element oven as a function of the radius of the strand and the mesh spacing and power drain of 20 KW.

FIG. 4 is a composite graph of FIGS. 1 and 2, indicating the regions applicable for high speed oven cooking with a De Luca Element Ratio close to 0.11 ohms/m2.

FIG. 5 illustrates a 24V oven comprising a mesh system.

FIG. 6 is an isometric view of the high speed oven including a conveyor belt and multiple wire mesh heating elements.

FIG. 7 is an isometric view of a 4-stack of high speed oven.

FIG. 8 is an isometric view of a 4-stack of high speed oven without a covering.

FIG. 9 is a table of energies consumed by various mesh wire segments of a high speed stored energy.

### DESCRIPTION

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for describing particular embodiments only and is not intended to be limiting of the present disclosure. As used herein, the singular forms “a,” “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

Hereinafter, exemplary embodiments of a radiant oven and a method of heating using multiple wire-mesh elements will be described in more detail with reference to the accompanying drawings.

When considering the use of Nichrome within an oven it is important to consider not only the resistive characteristics but also the black body emission of the element when hot.

With Regard to the General Characterization of Resistive Elements, the resistance is proportional to the length and resistivity, and inversely proportional to the area of the conductor.

R=L/A·ρ=L/A·ρ₀(α(T−T₀)+1) Eq.1

where ρ is the resistivity:

ρ=1/σ.,

L is the length of the conductor, A is its cross-sectional area, T is its temperature, T0 is a reference temperature (usually room temperature), ρ0 is the resistivity at T0, and α is the change in resistivity per unit of temperature as a percentage of ρ0. In the above expression, it is assumed that L and A remain unchanged within the temperature range. Also note that ρ0 and α are constants that depend on the conductor being considered. For Nichrome, ρ0 is the resistivity at 20 degrees C. or 1.10×10-6 and α=0.0004. From above, the increase in radius of a resistive element by a factor of two will decrease the resistance by a factor of four; the converse is also true.

Regarding the power dissipated from a resistive element, where, I is the current and R is the resistance in ohms, v is the voltage across the element, from Ohm's law it can be seen that, since v=iR,

P=i²R

In the case of an element with a constant voltage electrical source, such as a battery, the current passing through the element is a function of its resistance. Replacing R from above, and using ohms law,

P=v²/R=v²A/ρ₀L Eq. 2

In the case of a resistive element such as a nichrome wire the heat generated within the element quickly dissipates as radiation cooling the entire element.

Now, Considering the Blackbody Characterization of the Element: Assuming the element behaves as a blackbody, the Stefan-Boltzmann equation characterizes the power dissipated as radiation:

W=σ·A·T⁴ Eq. 3

Further, the wavelength λ, for which the emission intensity is highest, is given by Wien's Law as:

λₘₐₓ=b/T Eq. 4

### Where,

σ is the Stefan-Boltzmann constant of 5.670×10⁻⁸ W·m⁻²·K⁻⁴ and,

b is the Wien's displacement constant of 2.897×10-3 m·K.

In an application such as a cooking oven, requiring a preferred operating wavelength of 2 microns (2×10E-6) for maximum efficiency, the temperature of the element based on Wein's Law should approach 1400 degrees K. or 1127 degrees C. From the Stefan-Boltzmann equation, a small oven with two heating sides would have an operating surface area of approximately 4×0.25 m×0.25 m or 0.25 m2. Thus, W should approach 20,000 Watts for the oven.

In the case of creating a safe high power toaster or oven it is necessary for the system to operate at a low voltage of no more than 24 volts. Thus, using Eq. 2 with 20,000 W, the element will have a resistance of approximately 0.041 ohms, if 100% efficient at the operating temperature. Based on Eq. 1, a decrease in operating temperature to room temperature (from 1400 to 293 k) represents an approximate decrease in the resistivity of the element by about 1.44 times, and therefore an element whose resistance at room temperature is 0.0284 ohms is required.

Now, Considering the Relationship of the Resistance of the Element and the Characterization of the Element as a Blackbody:

The ratio of the resistance of the heater to the black body raditive area of the same heater becomes the critical design constraint for the oven; herein termed the De Luca Element Ratio. The ideal oven for foods operating over a 0.25 square meter area at 2 micron wavelength has a De Luca Element Ratio (at room temperature), of 0.1137 ohms/m2 (0.0284 ohms/0.25 m2). The De Luca Element Ratio is dependent solely on the resistance of the material and the radiative surface area but is independent of the voltage the system is operated. In addition, for wire, the length of the wire will not change the ratio.

Table 1 lists the resistance per meter of several common nichrome wire sizes as well as the De Luca Element Ratio for these elements. It is important to note that all these wires have a De Luca Element Ratio far greater than the 0.1137 required for an oven operated at 1400K, 24V, and over 0.25 m2. Clearly the use of a single wire with a voltage placed from end-to-end in order to achieve the power requirement is not feasible.

In contrast, a household pop-toaster, operated at 120V and 1500 W, over a smaller 0.338 m2 area at 500K would require a De Luca Element Ratio of 35.5. Thus a 1 meter nichrome wire of 0.001 m radius with a 120V placed across it would work appropriately.

TABLE 1

| | | | | | De Luca | Time To |
|---|---|---|---|---|---|---|
| | | Resistance | | | Element | Reach |
| | Cross | Per Meter | Surface Area | Weight | Ratio | 1400K |
| Wire | Sectional | Length | of 1 meter | Per | (at room | At 20 kw |
| Radius (m) | Area (m2) | (ohms) | length (m2) | Meter (g) | temp) | (sec) |
| 0.01 | 3.14E−04 | 0.0034 | 0.0628 | 2637 | 0.1 | 65.4 |
| 0.0015 | 7.06E−06 | 0.15 | 0.00942 | 59.3 | 16.2 | 1.47 |
| 0.001 | 3.14E−06 | 0.30 | .00628 | 26.3 | 47.7 | 0.654 |
| .0005 | 7.85E−07 | 1.38 | .00314 | 6.6 | 438 | 0.163 |
| 0.000191 | 1.139E−07 | 11.60 | 0.00120 | 0.957 | 9670 | 0.024 |
| 0.000127 | 5.064E−08 | 24.61 | 0.00079 | 0.425 | 30856 | 0.010 |
| 0.000022 | 1.551E−09 | 771.21 | 0.000138 | 0.013 | 5580486 | 0.0003 |

Clearly a lower resistance or a higher surface area is required to achieve a De Luca Element Ratio of close to 0.1137.

One way to achieve the De Luca Ratio of 0.1137 would be to use a large element of 2 cm radius. The problem with this relates to the inherent heat capacity of the element. Note from Table 1 that to raise the temperature to 1400K from room temperature would require 65.4 seconds and thus about 0.36 KWH of energy.

This Calculation is Derived from the Equation Relating Heat Energy to Specific Heat Capacity, where the Unit Quantity is in Terms of Mass is:

ΔQ=mcΔT

where ΔQ is the heat energy put into or taken out of the element (where P×time=ΔQ), m is the mass of the element, c is the specific heat capacity, and ΔT is the temperature differential where the initial temperature is subtracted from the final temperature.

Thus, the time required to heat the element would be extraordinarily long and not achieve the goal of quick cooking times.

Another way for lowering the resistance is to place multiple resistors in parallel. Kirkoffs law's predict the cumulative result of resistors placed in parallel.

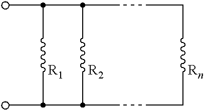

$$\frac{1}{{R}_{total}} = \frac{1}{{R}_{1}} + \frac{1}{{R}_{2}} + … + \frac{1}{{R}_{n}} \qquad Eq . 5$$

The following Table 2 lists the number of conductors for each of the elements in Table 1, as derived using equation 5, that would need to be placed in parallel in order to achieve a De Luca Element Ratio of 0.1137. Clearly placing and distributing these elements evenly across the surface would be extremely difficult and impossible for manufacture. Also note that the required time to heat the combined mass of the elements to 1400K from room temperature at 20 KW for elements with a radius of greater than 0.0002 meters is too large with respect to an overall cooking time of several seconds.

TABLE 2

| | De Luca | Number of | | Time To Reach |
|---|---|---|---|---|
| | Element | Parallel Elements | Total | 1400K At 20 |
| Wire | Ratio for single | Required to | Weight/ | kw (sec) From |
| Radius | element (@ | Achieve De Luca | Meter | Room |
| (m) | Room Temp) | Ratio of 0.1137 | (g) | Temp |
| 0.01 | 0.1 | 1 | 2637 | 65.4 |
| 0.0015 | 16.2 | 12 | 711 | 17.6 |
| 0.001 | 47.7 | 22 | 579 | 14.4 |
| .0005 | 438 | 63 | 415 | 10.3 |
| 0.000191 | 9670 | 267 | 255 | 6.3 |
| 0.000127 | 30856 | 493 | 209 | 5.2 |
| 0.000022 | 5580486 | 6838 | 88 | 2.18 |

In summary, the following invention allows for the creation of a high power oven by using a resistive mesh element. The heater element designed so as to allow for the desired wavelength output by modifying both the thickness of the mesh as well as the surface area from which heat radiates. The heater consisting of a single unit mesh that is easily assembled into the oven and having a low mass so as to allow for a very quick heat-up (on the order of less than a few seconds).

Specifically, the wire mesh cloth design calibrated to have the correct De Luca Element Ratio for a fast response (less than 2 sec) oven application operating at 1400 degrees K.

According to exemplary embodiments, a mesh design for operating a quick response time oven consisting of a nichrome wire mesh with strand diameter of 0.3 mm, and spacing between strands of 0.3 mm, and operating voltage of 24V.

In considering the best mesh design, it is important to evaluate the blackbody radiative area as well as the resistance of the element as a function of the following:

1) The number of strands per unit area of the mesh

2) The radius of the mesh strands

3) The mesh strand material

4) The potential for radiation occlusion between strands.

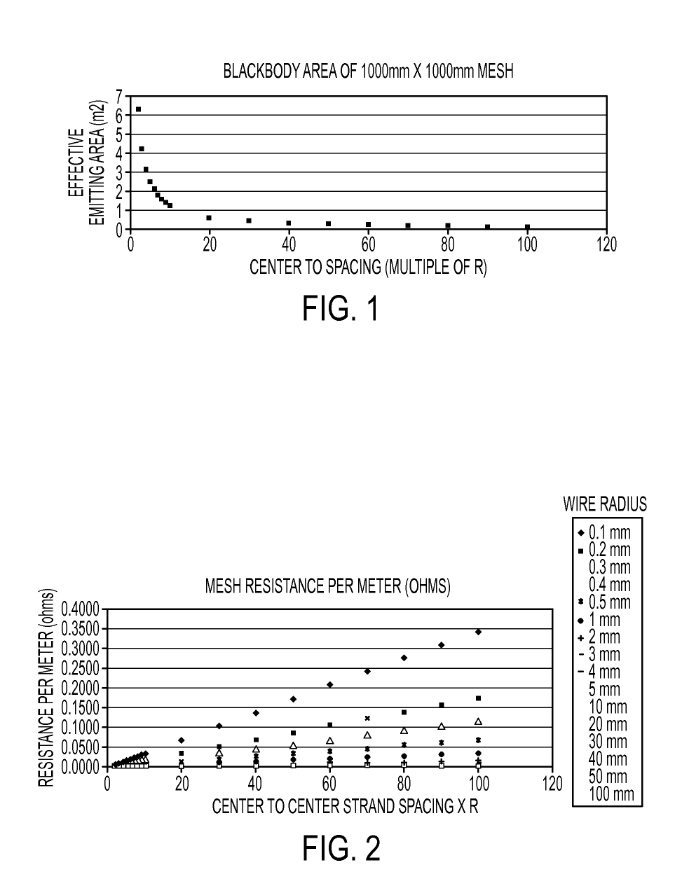

FIG. 1 describes the blackbody area as a function of the number of strands and the strand spacing of the mesh. Interestingly, the surface area is independent of the radius of the wire strand if the spacing is made a function of the radius.

Using equation 5 from above, the resistance of the mesh can be calculated for a specific wire strand radius. FIG. 2 illustrates the electrical resistance of a nichrome mesh element as a function of the radius of the strand and the mesh spacing. Limitation in Equation 5 become apparent as the number of strands becomes very high and the resistance becomes very low; thus atomic effects associated with random movement of electrons in the metal at room temperature form a minimum resistive threshold.

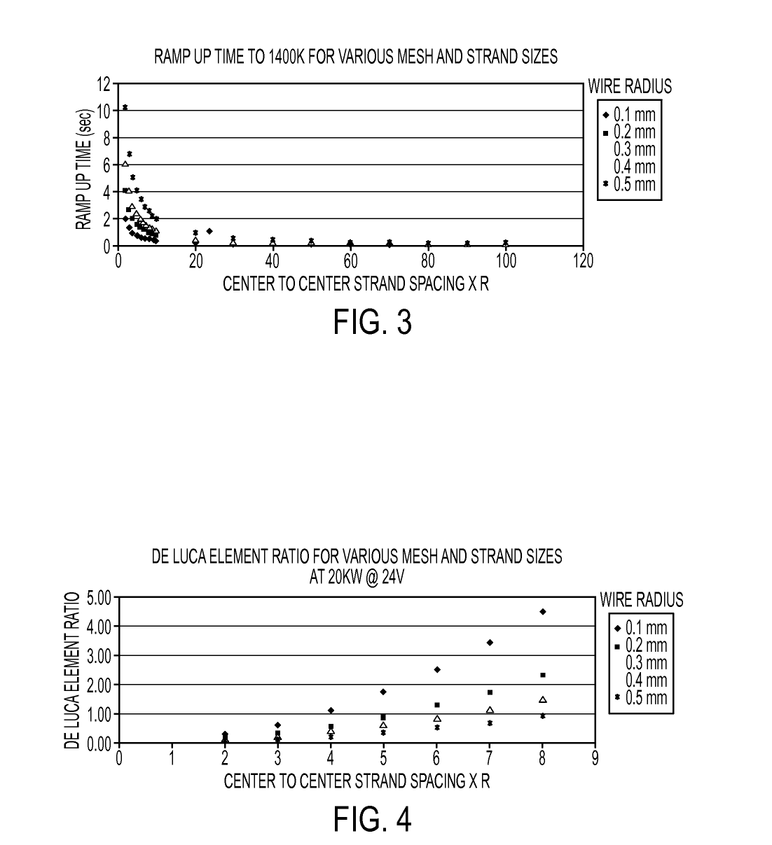

Using nichrome as the strand material in the mesh and operating the system at 20 KW, the ramp up time to achieve an operating temperature of 1400 degrees K. is a function of the strand radius and the mesh spacing (note that a nominal mesh size of two times 125 mm×250 mm is used). FIG. 3 illustrates the region below which a ramp up of less than 2 seconds is achievable (note that wire radius above 0.5 mm are not shown due to the long required ramp up times).

FIG. 4 is a composite graph of FIGS. 1 and 2, indicating the regions applicable for high speed oven cooking with a De Luca Element Ratio close to 0.11 ohms/m2.

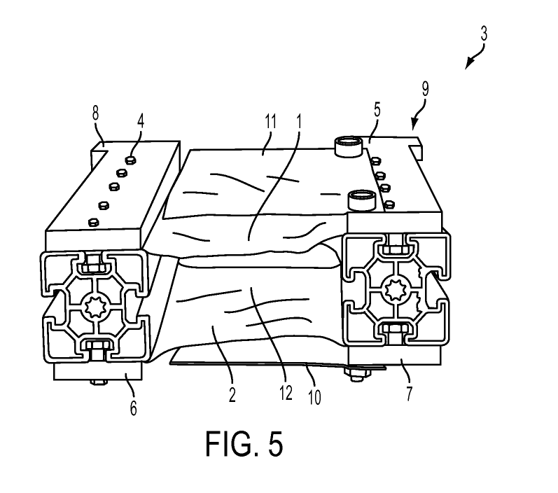

FIG. 5 is a photograph of oven 3 with top and bottom wire mesh elements 1 and 2 each 125 mm×230 mm and operated at 24V. Each wire mesh (1 and 2) has 766-125 mm long filaments woven across 416-230 mm long elements, each element 0.3 mm in diameter. A 24 V battery source is placed across the length of the 766 elements at bus bars 4 and 5. The wire surface area for a single strand of 0.14 mm diameter wire is 0.000440 m2/m. Thus, a total surface area (for combined top and bottom elements) can be calculated as:

Total Blackbody Radiating Area=2×0.000440×(416×0.23+766×0.125)=0.168 m2

The resistance across bus bars 4 and 5 as well as 6 and 7 was measured at 0.04+/−0.01 ohms. (Note that bars 4 and 6 as well as 5 and 7 are connected by cross bars 8 and 9 respectively.) Thus calculating the De Luca Element Ratio for the elements gives:

0.02 ohms+/−0.01 ohms/0.168 m²=0.119+/−0.06 ohms/m²

which is within experimental error to the desired vale for the De Luca Element Ratio providing the most optimal cook time. These experimental values also match closely to the expected values shown in FIG. 4.

Panels 10 and 11 are reflectors used to help focus the radiation towards the item placed in area 12.

According to exemplary embodiments, a mesh is a 0.3 mm×0.3 mm mesh (2×R) using 0.14 mm diameter nichrome wire and operates well at 24V.

A oven based on using wire mesh segments wherein the item to be cooked is transported on a conveyor between separate segments of wire mesh allowing for a continuous flow process versus an intermittent conveyance. Each wire mesh segment or heating element can be individually controlled for intensity and/or duration. This embodiment can provide the advantage of heating or cooking with a high flow rate. Also, the heating profile for each item can be optimally customized. The customization can be achieved without reconfiguring the hardware of the oven.

Each length of a wire mesh segment and intervening gaps between lengths of the wire mesh segments can provide the equivalent effect of an on-and-off pulsed oven. This can permit for a continuous process flow, for example, when cooking a food item

In exemplary embodiments, a conveyance belt runs at a constant speed and an item to be cooked is placed on the belt. In some cases wire mesh segments are disposed to reflect on both the top and bottom surfaces of the belt. In other cases, the wire mesh segments can be disposed on either the top or the bottom surface of the belt.

As the object or food item to be heated is conveyed forward by the belt, the wire mesh segments can heat the item. A wire mesh segment or heating element may either be already on or may turn on when the item approaches the segment. The item then passes under the wire mesh segment and heats.

In some embodiments, as the item is conveyed or moves past the wire mesh element, the item can be cooled. A duration of the cool-off period can be achieved with a gap. In a preferred embodiment, the wire mesh element can comprise a nichrome heating element.

In the absence of an item to be heated, the wire mesh heating element can be turned off. For example, if the normal process using a wire mesh segment desires 4 seconds on time and then 8 seconds off time, for a belt moving at 60″ a minute, a 4″ long element would be followed by an 8″ gap.

In some embodiments, shielding can be provided to reflect the infrared radiation.

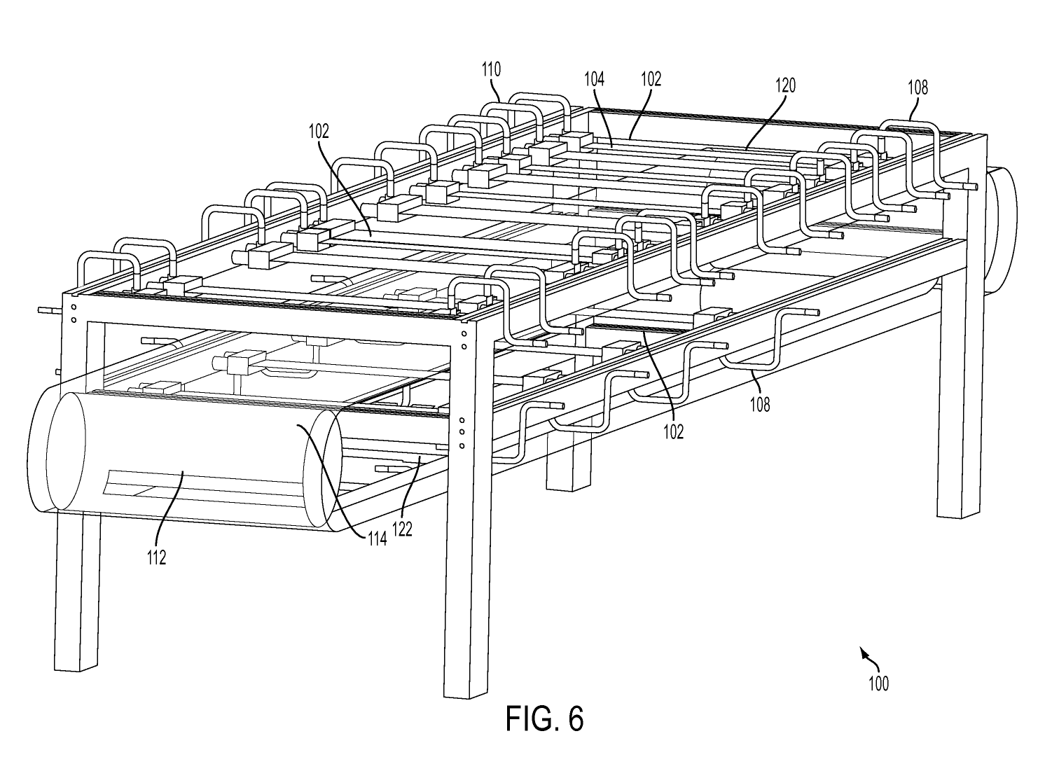

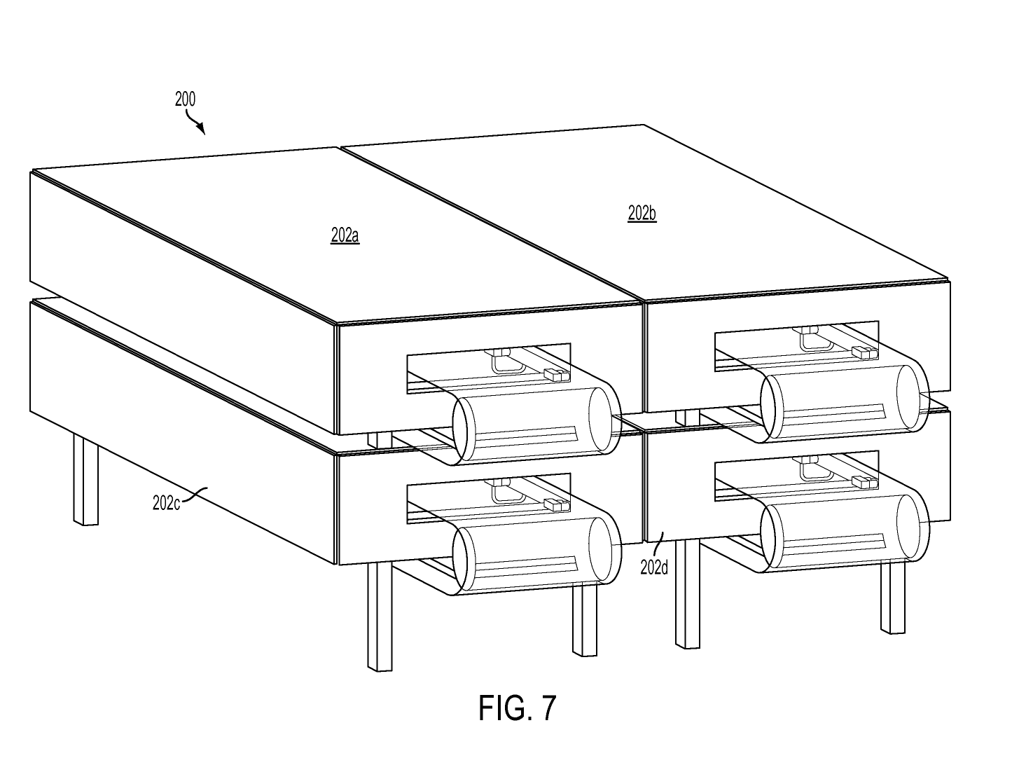

FIG. 6 is an isometric view of a radiant oven 100 comprising multiple wire mesh heating elements 102. A gap 104 is disposed between two of the multiple wire mesh heating elements 102. Buses 108 and 110 supply an electrical current to each of the multiple wire mesh heating elements 102. A movable belt 114 disposed over rollers/motors 112 is provided. An item to heated, for example, food can be disposed on belt 114. Some of the multiple wire mesh heating elements 102 can be disposed above the belt 114 in a plane 120. Some of the multiple wire mesh heating elements 102 can be disposed below the belt 114 in a plane 122. Radiant oven 100 can be disposed in an enclosure (not shown). An enclosure is visible in FIG. 7.

FIG. 7 is an isometric view a 4-stack 400 of a radiant oven 202a, 202b, 202c and 202d disposed in an enclosure.

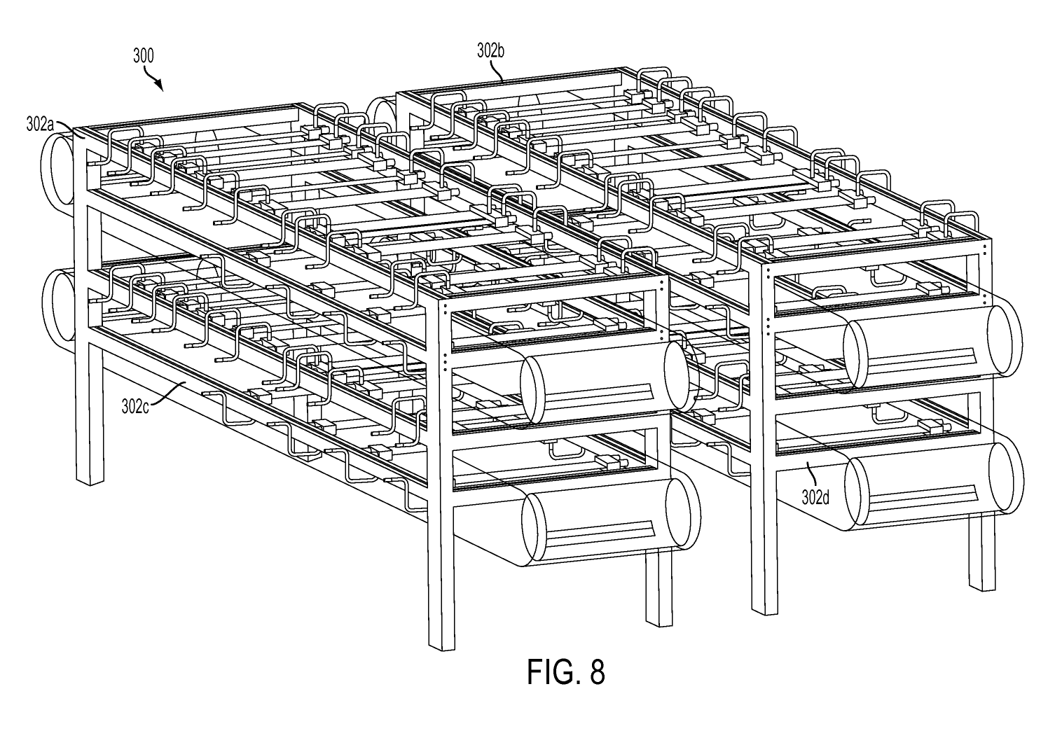

FIG. 8 is an isometric view of a 4-stach 300 of a radiant oven 302a, 302b, 302c and 302d.

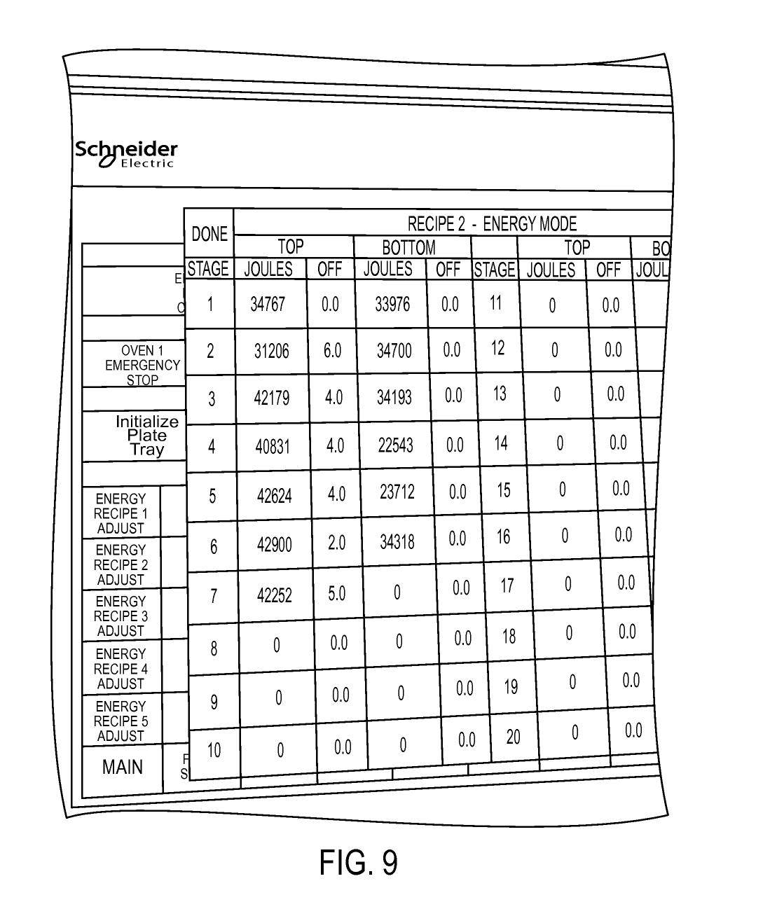

FIG. 9 is a table of energies consumed by various mesh wire segments of a high speed stored energy. The mesh wire segments output heat at a tremendous rate. The food below the wire mesh element needs an off-period or rest period where the heat received by the outer surface of the food item can be conducted to the inner surfaces of the food item. One method of providing a rest period for the food to cycle the wire mesh segments when the food item is static, i.e., not moving, under the heating element. However, with a movable belt on which the food item is disposed, the rest period for a food item can be provided by having a gap substituting for the off-cycle of the wire mesh heating element.

In exemplary embodiments, a pizza can be cooked in 60 seconds in a static wire mesh oven using the duration times (in seconds) presented in the table below. These durations can be translated into segment lengths for the wire mesh elements and the intervening gaps in a 60″ conveyer belt equipped oven. In the belt equipped oven, the wire mesh heating segments can be deployed in two planes, namely, top and bottom. The table provides exemplary cycle times wire mesh segment lengths in a 60″ oven. The belt oven of the present invention can cut pizza cooking times in half as compared to the prior art belt ovens. In other embodiments, the belt oven of the present invention can cut pizza cooking times in quarter as compared to the prior art belt ovens.

| Top On | Top Off | Bottom on | Bottom off |
|---|---|---|---|
| 3 | 0 | 3 | 0 |
| 3 | 6 | 3 | 0 |
| 4 | 4 | 3 | 0 |
| 4 | 4 | 2 | 0 |
| 4 | 4 | 0 | 0 |
| 4 | 2 | 3 | 0 |
| 4 | 5 | 0 | 0 |
| 2 | 5 | 0 | 0 |

The examples presented herein are intended to illustrate potential and specific implementations. It can be appreciated that the examples are intended primarily for purposes of illustration for those skilled in the art. The diagrams depicted herein are provided by way of example. There can be variations to these diagrams or the operations described herein without departing from the spirit of the invention. For instance, in certain cases, method steps or operations can be performed in differing order, or operations can be added, deleted or modified.

1-24. (canceled)

25. A radiant oven comprising:
a cavity configured to receive a load;
a power supply; and
a main heater comprising a multiple of heating elements to be driven by the power supply, the multiple heating elements being sized and positioned about the cavity to heat the load, and a gap between each of the multiple heating elements,
wherein each of the multiple heating elements is individually controlled for intensity or duration.

26. The radiant oven of claim 25, wherein the power supply comprises a stored energy device.

27. The radiant oven of claim 25, wherein the multiple heating elements are arranged in parallel in at least one plane.

28. The radiant oven of claim 25, wherein a ratio of a resistance of at least one of the multiple heating elements to a radiative black body area of the at least one of the multiple heating elements is less than 2 ohms/m².

29. The radiant oven of claim 25, wherein at least one of the multiple heating elements is capable of reaching about 1400° Kelvin from room temperature in less than 10.3 seconds.

30. The radiant oven of claim 25, wherein at least one of the heating elements comprises a wire mesh.

31. The radiant oven of claim 25, further comprising a movable belt configured to support the load as the load is moved through the cavity.

32. The radiant oven of claim 25, further comprising:
a tray configured to support the cooking load; and
a rotator configured to move the tray in a concentric motion for evenly radiating the cooking load.

33. The radiant oven of claim 31, wherein a distance of a top surface of the belt to the multiple heating elements is adjustable.

34. The radiant oven of claim 25, further comprising multiple relays, each relay configured to cycle a current connection to at least one of the multiple heating elements, and a control circuit configured to control each relay of the multiple relays.

35. The radiant oven of claim 25, further comprising a temperature sensor in communication with the control circuit.

36. The radiant oven of claim 25, further comprising a control circuit configured to control a current to each of the multiple heating elements by cycling each of the currents on and off at a duty ratio in response to a user input, or automatically in response to a measured parameter indicting a condition of the load.

37. The radiant oven of claim 25, wherein at least one of the multiple heating elements comprises a wire mesh, and the radiant oven further comprises:
a first bus comprising a tensioned support attached to a first side of the wire mesh; and
a second bus comprising a tensioned support attached to a second side of the wire mesh, wherein the second side is opposite the first side.

38. The radiant oven of claim 25, further comprising a control circuit configured to preheat at least one of the multiple heating elements using a small current.

39. The radiant oven of claim 25, further comprising a voltage control circuit configured to vary the voltage of each of the multiple heating elements.

40. The radiant oven of claim 25, further comprising a charger configured to charge the stored energy device by drawing power from an external power supply.

41. The radiant oven of claim 31, wherein the movable belt moves at a constant speed.

42. The radiant oven of claim 31, wherein the belt for supporting the cooking load is made of an electrically non-conductive material that is able to withstand high temperature.

43. The radiant oven of claim 25, further comprising a sensor for monitoring gases or particles emitted by the cooking load.

44. The radiant oven of claim 25, further comprising an energy calculation circuit for calculating an energy consumed by the main heater by integrating power with respect to time.

45. The radiant oven of claim 25, wherein a minimum distance from the cooking load to any of the multiple heating elements is not less than one half of an inch.
